(19) United States
(12) Patent Application Publication
(10) Pub. No.: US 2025/0256568 A1
(43) Pub. Date: Aug. 14, 2025

(54) SYSTEM AND METHOD FOR SYNCHRONIZING MOTOR SPEED FOR VEHICLES WITH DISCONNECT CLUTCH

(71) Applicant: Ford Global Technologies, LLC, Dearborn, MI (US)

(72) Inventors: Yanan Zhao, Ann Arbor, MI (US); Yang Xu, Canton, MI (US); Matthew Shelton, Grosse Ile, MI (US); Zhengyu Dai, Canton, MI (US); Joseph Jay Torres, Dearborn, MI (US)

(21) Appl. No.: 18/436,334

(22) Filed: Feb. 8, 2024

(51) Int. Cl. B60K 23/08; B60K 1/02; B60K 17/356; B60L 15/20

(52) U.S. Cl. CPC B60K 23/0808; B60K 1/02; B60K 17/356; B60L 15/2054; B60L 2240/421; B60L 2240/423; B60L 2240/507

(57) ABSTRACT

Methods and system are described for closing a driveline disconnect clutch that selectively decouples an electric machine from wheels of a vehicle are described. In one example, closing of the driveline disconnect clutch is divided into three closing phases and one of the closing phases is divided into three speed phases to provide a desired level of driveline control.

### FIELD

The present description relates generally to methods and systems for controlling closing of a driveline disconnect clutch of a vehicle that includes an electric propulsion source.

### BACKGROUND/SUMMARY

Four-wheel drive electric vehicles may include a driveline disconnect clutch for decoupling an electric machine from the driveline. Decoupling the electric machine from the driveline may increase vehicle efficiency. Therefore, decoupling an electric machine from a four-wheel drive electric vehicle may be useful to increase vehicle driving range and reduce a vehicle user's “range anxiety.” The users “range anxiety” may be a concern that their four-wheel drive vehicle may not have a capacity to reach a charging station to recharge the electric vehicle. While the driveline disconnect clutch may useful to reduce “range anxiety,” it may also increase driveline torque disturbances and degrade vehicle drivability. Therefore, it may be desirable to provide an electric four-wheel drive vehicle that has increased efficiency and lower driveline torque disturbances.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of a vehicle driveline is shown;

FIG. 2 shows an example sequence for closing a disconnect clutch that couples an electric machine with a driveline;

FIG. 3 is a plot of different electric machine speed profiles;

FIG. 4 shows a comparison of example electric machine speed synchronization phases;

FIGS. 5 and 6 show example methods for closing a driveline disconnect clutch.

### DETAILED DESCRIPTION

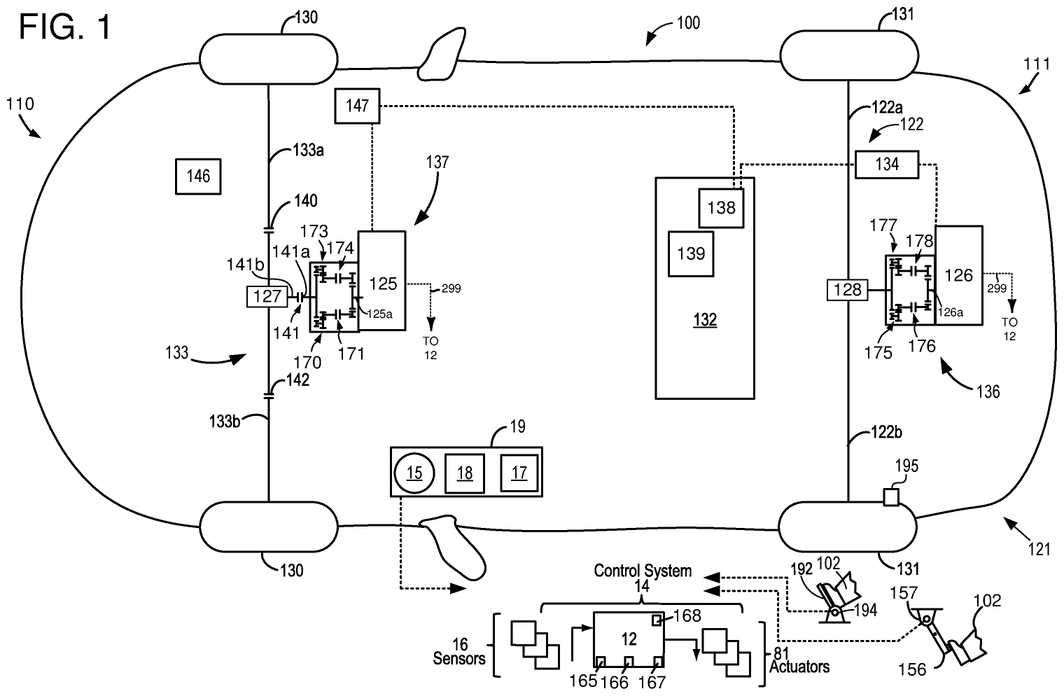

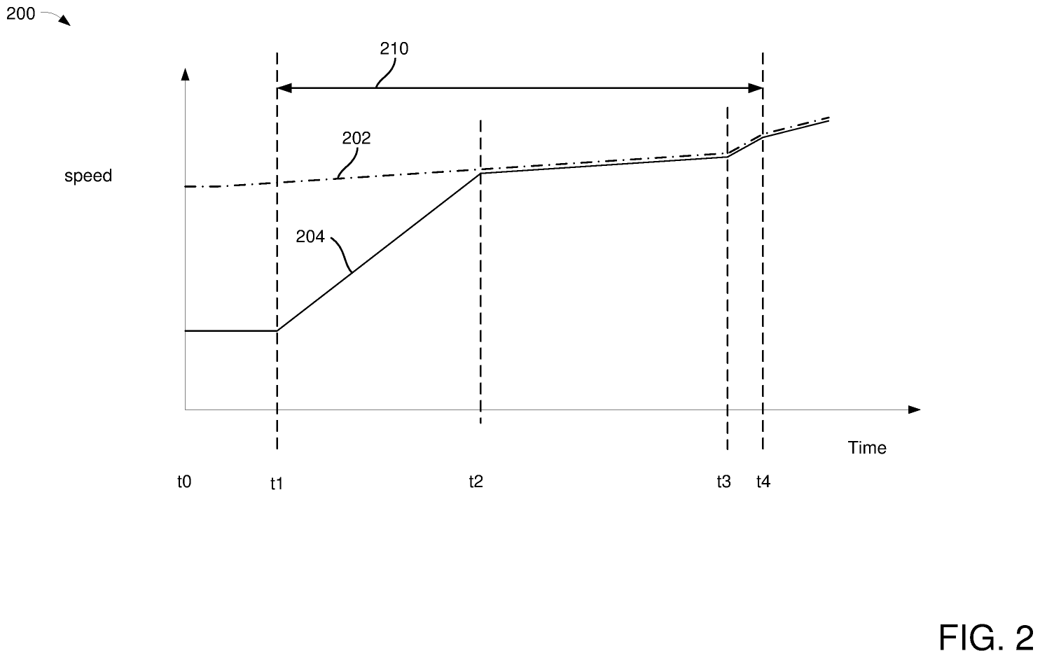

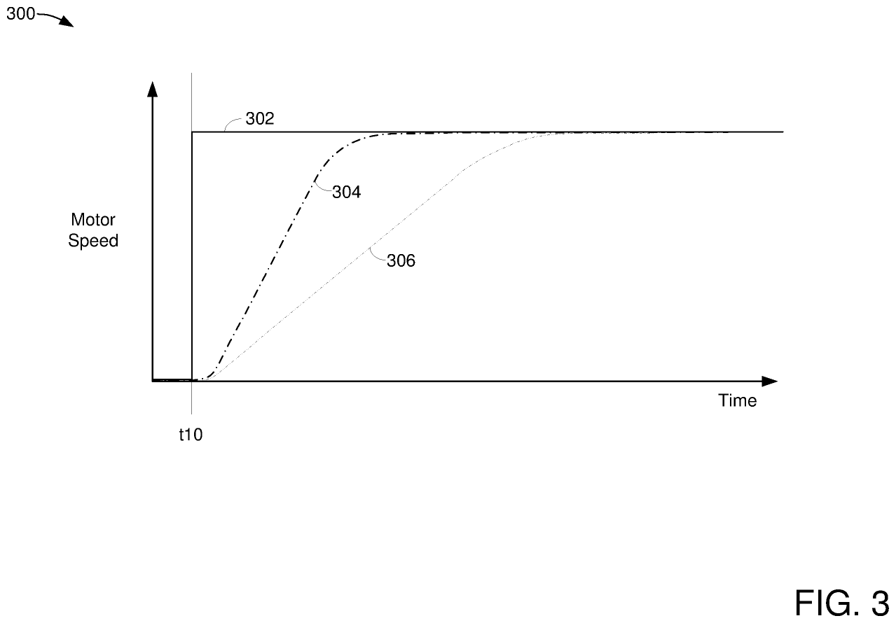

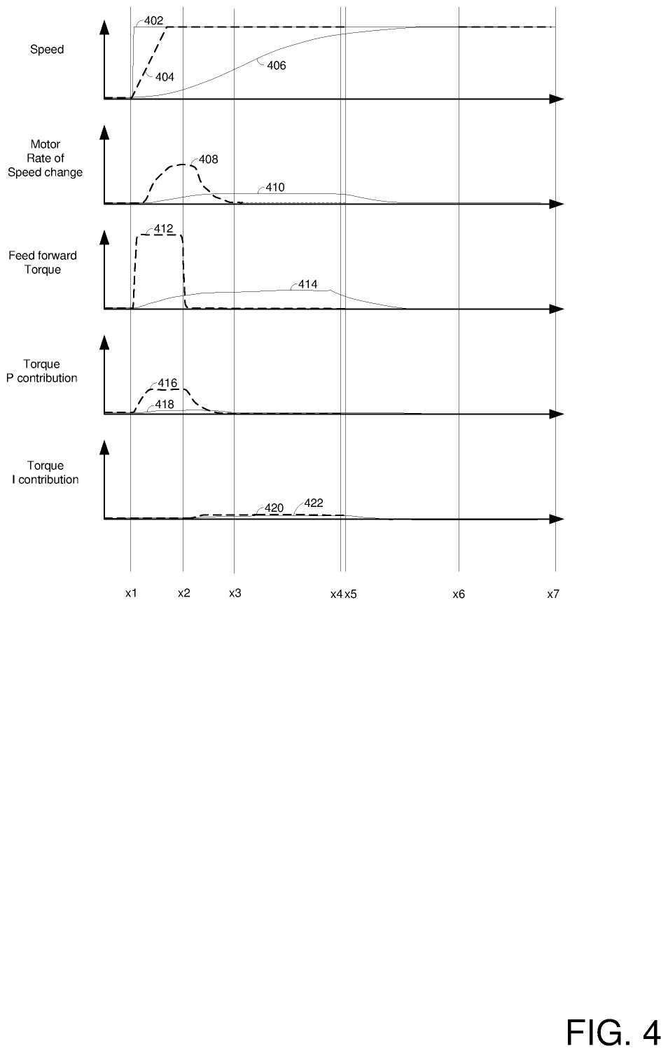

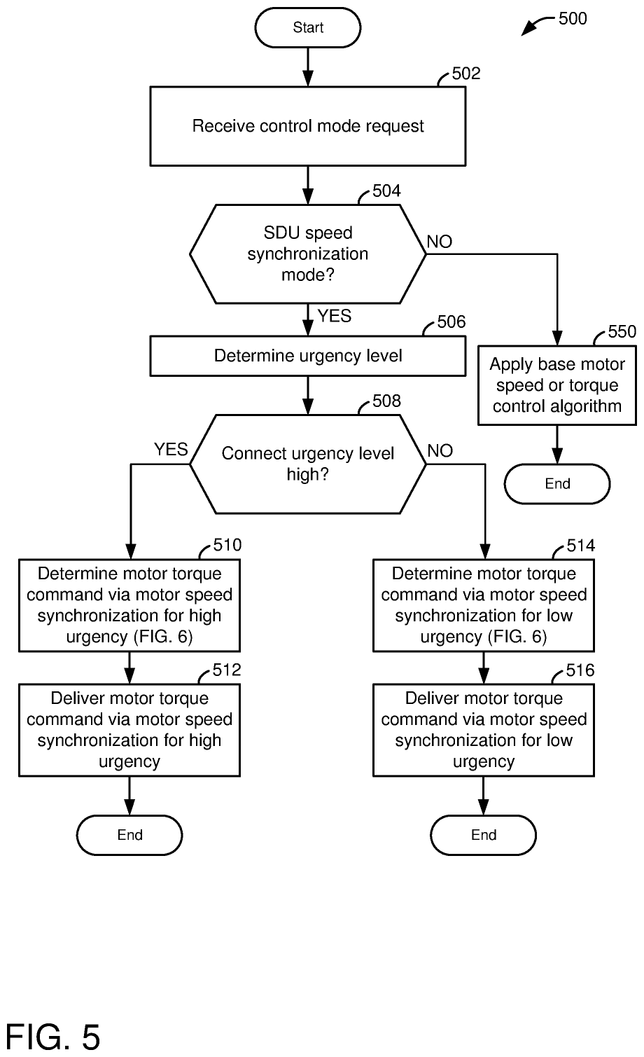

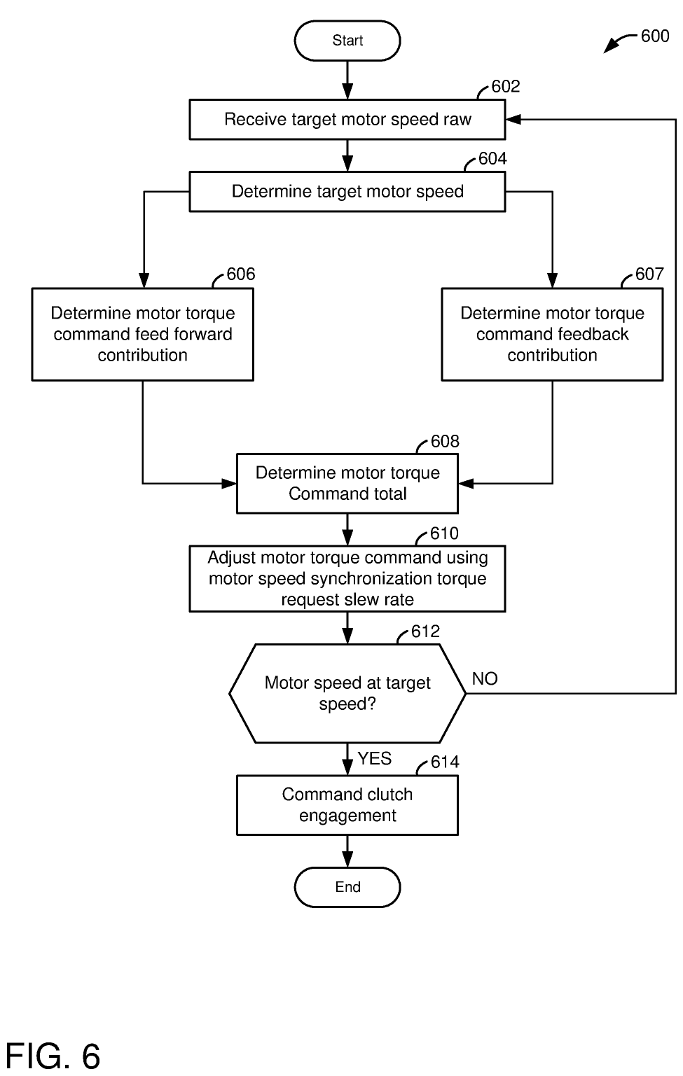

The following description relates to systems and methods for managing closing of a driveline disconnect clutch of an electric vehicle. In one example, a driveline disconnect clutch of a four-wheel drive electric vehicle may be closed according to a prescribed closing sequence that includes an electric machine speed profile that is dependent on urgency of driveline disconnect clutch closing. A driveline of a non-limiting four-wheel drive electric vehicle is shown in FIG. 1. FIG. 2 shows an example disconnect clutch closing sequence. Example electric machine speed profiles are shown in FIG. 3. Plots for comparing electric machine speed synchronization phases are shown in FIG. 4. FIGS. 5 and 6 show flowcharts of methods for controlling driveline disconnect clutch closing.

A four-wheel drive vehicle may include a propulsion source for a front axle and a propulsion source for a rear axle. One of the propulsion sources may be a primary propulsion source that is continuously coupled to an axle while the other propulsion source may be a secondary propulsion source that is selectively coupled to an axle. Uncoupling the secondary propulsion source for an axle may conserve electric energy. However, reconnecting the secondary propulsion source to an axle may increase a possibility of a driveline torque disturbance and reduce vehicle drivability. The torque disturbance may be a result of closing the driveline disconnect clutch when the secondary propulsion source is rotating a portion of a driveline at a rotational speed that is different than a rotational speed of driveline components that are rotating due to vehicle motion. Further, increased wheel slip and loss of traction may result if four-wheel drive is not activated in a timely manner when a vehicle transitions from traveling on a surface with a relatively high coefficient of friction to a surface that has a relatively low coefficient of friction.

The inventors herein have recognized the above-mentioned issues and have developed a method for operating a vehicle, comprising: adjusting torque of an electric machine during a speed synchronization phase of a closing of a driveline disconnect clutch according to separate and distinct speed control phases within the speed synchronization phase.

By separating a speed synchronization phase of a driveline disconnect clutch closing sequence into different speed control phases, it may be possible to provide the technical results of timely four-wheel driveline engagement and reduced driveline torque disturbances during driveline disconnect clutch closing. In particular, the speed synchronization phase may be split or separated into three speed control phases so that electric machine rotational speed may cause one side of a driveline disconnect clutch speed to rotate at a rotational speed of the other side of the driveline disconnect clutch without overshoot. Gains (e.g., real number multipliers) of a controller that manages speed of the electric machine may be different for each of the three speed control phases so that there may be less possibility of speed overshoot or speed undershoot. Consequently, the driveline disconnect clutch may be timely closed when there is a lower rotational speed differential across the driveline disconnect clutch, thereby increasing traction and reducing a possibility of driveline torque disturbances during driveline disconnect clutch closing.

The present description may provide several advantages. In particular, the approach may provide timely closing for a driveline disconnect clutch closing. Further, the approach may reduce torque disturbances that result from closing a driveline disconnect clutch.

FIG. 1 illustrates an example vehicle propulsion system 100 for vehicle 121. A front portion of vehicle 121 is indicated at 110 and a rear portion of vehicle 121 is indicated at 111. Vehicle propulsion system 100 includes at two propulsion sources including front electric machine 125 and rear electric machine 126. Electric machines 125 and 126 may consume or generate electrical power depending on their operating mode. Throughout FIG. 1, mechanical connections between various components are illustrated as solid lines, whereas electrical connections between various components are illustrated as dashed lines.

Vehicle propulsion system 100 has a front axle 133 and a rear axle 122. In some examples, rear axle may comprise two half shafts, for example first half shaft 122a, and second half shaft 122b. Likewise, front axle 133 may comprise a first half shaft 133a and a second half shaft 133b. Vehicle propulsion system 100 further has front wheels 130 and rear wheels 131. In this example, front wheels 130 may be selectively driven via electric machine 125. Rear wheels 131 may be driven via electric machine 126.

The rear axle 122 is coupled to electric machine 126, and electric machine 126 may be referred to as a main drive unit (MDU). Rear drive unit 136 may transfer power from electric machine 126 to axle 122 resulting in rotation of drive wheels 131. Rear drive unit 136 may include a low gear set 175 and a high gear set 177 that are coupled to electric machine 126 via output shaft 126a of rear electric machine 126. Low gear set 175 may be engaged via fully closing low gear clutch 176. High gear set 177 may be engaged via fully closing high gear clutch 178. High gear clutch 178 and low gear clutch 176 may be opened and closed via commands received by rear drive unit 136 over controller area network (CAN) 299. Alternatively, high gear clutch 178 and low gear clutch 76 may be opened and closed via digital outputs or pulse widths provided via control system 14. Rear drive unit 136 may include differential 128 so that torque may be provided to axle 122a and to axle 122b. In some examples, an electrically controlled differential clutch (not shown) may be included in rear drive unit 136.

The front axle 133 may be selectively coupled and decoupled to electric machine 125 via disconnect clutch 141. Disconnect clutch 141 includes an input side 141a and an output side 141b. The input side may be coupled to electric machine 125. The output side may be coupled to differential 127. In this example, electric machine 125 may be referred to as a secondary drive unit (SDU). Alternatively, disconnect clutches 140 and 142 may selectively couple and decouple front wheels 130 to electric machine 125. Front drive unit 137 may transfer power from electric machine 125 to axle 133 resulting in rotation of front wheels 130. Front drive unit 137 may include a low gear set 170 and a high gear set 173 that are coupled to electric machine 125 via output shaft 125a of front electric machine 125. Low gear set 170 may be engaged via fully closing low gear clutch 171. High gear set 173 may be engaged via fully closing high gear clutch 174. High gear clutch 174 and low gear clutch 171 may be opened and closed via commands received by front drive unit 137 over CAN 299. Alternatively, high gear clutch 174 and low gear clutch 171 may be opened and closed via digital outputs or pulse widths provided via control system 14. Front drive unit 137 may include differential 127 so that torque may be provided to axle 133a and to axle 133b. In some examples, an electrically controlled differential clutch (not shown) may be included in rear drive unit 136.

Electric machines 125 and 126 may receive electrical power from onboard electrical energy storage device 132. Furthermore, electric machines 125 and 126 may provide a generator function to convert the vehicle's kinetic energy into electrical energy, where the electrical energy may be stored at electric energy storage device 132 for later use by the electric machine 125 and/or electric machine 126. A first inverter system controller (ISC1) 134 may convert alternating current generated by rear electric machine 126 to direct current for storage at the electric energy storage device 132 and vice versa. A second inverter system controller (ISC2) 147 may convert alternating current generated by front electric machine 125 to direct current for storage at the electric energy storage device 132 and vice versa. Electric energy storage device 132 may be a battery, capacitor, inductor, or other electric energy storage device.

In some examples, electric energy storage device 132 may be configured to store electrical energy that may be supplied to other electrical loads residing on-board the vehicle (other than the motor), including cabin heating and air conditioning, headlights, cabin audio and video systems, etc.

Control system 14 may communicate with one or more of electric machine 125, electric machine 126, energy storage device 132, etc. Control system 14 may receive sensory feedback information from one or more of electric machine 125, electric machine 126, energy storage device 132, etc. Inverters may be included as part of electric machines 125 and 126 when the electric machines are alternating current (AC) electric machines. Further, control system 14 may send control signals to one or more of electric machine 125, electric machine 126, energy storage device 132, etc., responsive to this sensory feedback. Control system 14 may receive an indication of an operator requested output of the vehicle propulsion system from a human operator 102, or an autonomous controller. For example, control system 14 may receive sensory feedback from pedal position sensor 194 which communicates with pedal 192. Pedal 192 may refer schematically to a driver demand pedal. Similarly, control system 14 may receive an indication of an operator requested vehicle caliper application via a human operator 102, or an autonomous controller. For example, control system 14 may receive sensory feedback from pedal position sensor 157 which communicates with caliper pedal 156.

Energy storage device 132 may periodically receive electrical energy from a power source such as a stationary power grid (not shown) residing external to the vehicle (e.g., not part of the vehicle). As a non-limiting example, vehicle propulsion system 100 may be configured as a plug-in electric vehicle (EV), whereby electrical energy may be supplied to energy storage device 132 via the power grid (not shown).

Electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 12). Power distribution module 138 controls flow of power into and out of electric energy storage device 132.

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Vehicle propulsion system 100 may further include a motor electronics coolant pump (MECP) 146. MECP 146 may be used to circulate coolant to diffuse heat generated by at least electric machine 120 of vehicle propulsion system 100, and the electronics system. MECP may receive electrical power from onboard energy storage device 132, as an example.

Controller 12 may comprise a portion of a control system 14. In some examples, controller 12 may be a single controller of the vehicle. Control system 14 is shown receiving information from a plurality of sensors 16 (various examples of which are described herein) and sending control signals to a plurality of actuators 81 (various examples of which are described herein). As one example, sensors 16 may include tire pressure sensor(s) (not shown), wheel speed sensor(s) 195, etc. In some examples, sensors associated with electric machine 125, electric machine 126, wheel speed sensor 195, etc., may communicate information to controller 12, regarding various states of electric machine operation. Controller 12 includes non-transitory (e.g., read exclusive memory) 165, random access memory 166, digital inputs/outputs 168, and a microcontroller 167.

Vehicle propulsion system 100 may also include an on-board navigation system 17 (for example, a Global Positioning System) on dashboard 19 that an operator of the vehicle may interact with. The navigation system 17 may include one or more location sensors for assisting in estimating a location (e.g., geographical coordinates) of the vehicle. For example, on-board navigation system 17 may receive signals from GPS satellites (not shown), and from the signal identify the geographical location of the vehicle. In some examples, the geographical location coordinates may be communicated to controller 12.

Dashboard 19 may further include a display system 18 configured to display information to the vehicle operator. Display system 18 may comprise, as a non-limiting example, a touchscreen, or human machine interface (HMI), display which enables the vehicle operator to view graphical information as well as input commands. In some examples, display system 18 may be connected wirelessly to the internet (not shown) via controller (e.g. 12). As such, in some examples, the vehicle operator may communicate via display system 18 with an internet site or software application (app).

Dashboard 19 may further include an operator interface 15 (e.g., a human/machine interface) via which the vehicle operator may adjust the operating status of the vehicle. Specifically, the operator interface 15 may be configured to initiate and/or terminate operation of the vehicle driveline (e.g., electric machine 125 and electric machine 126) based on an operator input. Various examples of the operator interface 15 may include interfaces that apply a physical apparatus, such as an active key, that may be inserted into the operator interface 15 to start the electric machines 125 and 126 and to turn on the vehicle, or may be removed to shut down the electric machines 125 and 126 to turn off the vehicle.

The system of FIG. 1 provides for a vehicle system, comprising: a first electric machine selectively coupled to a front axle via a disconnect clutch; a second electric machine coupled to a rear axle; one or more controllers including executable instructions stored in non-transitory memory that cause the one or more controllers to control a speed of the first electric machine during a closing sequence for the disconnect clutch according to a driveline speed, where the speed of the first electric machine is controlled based on an urgency of engagement of the disconnect clutch, where the urgency of engagement is based on one or more vehicle operating conditions. In a first example, the vehicle system includes where the closing sequence includes three phases, the three phases including an electric machine speed synchronization phase, a disconnect clutch engagement phase, and an electric machine torque increasing phase, where the disconnect clutch engagement phase follows the electric machine speed synchronization phase and precedes the electric machine torque increasing phase. In a second example that may include the first example, the vehicle system includes where the electric machine speed synchronization phase is sectioned into a first phase, a second phase, and a third phase. In a third example that may include one or both of the first and second examples, the vehicle system includes where the first phase is a rate of electric machine speed change increasing and sustaining phase, where the second phase is a rate of electric machine speed change decreasing phase, and the third phase is a rate of electric machine speed change stabilization phase. In a fourth example that may include one or more of the first through third examples, the vehicle system further comprises additional executable instructions that cause the one or more controllers to adjust torque of the first electric machine in response to a present speed of the first electric machine. In a fifth example that may include one or more of the first through fourth examples, the vehicle system includes where torque of the first electric machine is adjusted via a feed forward controller and a proportional/integral controller. In a sixth example that may include one or more of the first through fifth examples, the vehicle system includes where the feed forward controller includes a motor speed slew rate target value for each of a plurality of different urgency levels, and where the proportional/integral controller includes gains for the plurality of different urgency levels. In a seventh example that may include one or more of the first through sixth examples, the vehicle system includes where the proportional/integral controller includes gains that are dynamically adjusted based on a target motor speed and a motor speed error for three speed control phases of an electric machine speed synchronization phase.

Referring now to FIG. 2, a plot of an example prophetic SDU coupling sequence is shown. The prophetic SDU coupling sequence may mechanically couple a SDU with an axle and wheels that are coupled to the axle. The SDU coupling sequence may be performed beginning when a disconnect clutch is open and the SDU is uncoupled from its associated axle.

Plot 200 includes a dashed-dot line 202 that represents driveline rotational speed. The driveline rotational speed may be based on an average of the wheel speeds of the front axle and the gear ratio between the electric machine and the disconnect clutch. That is, the driveline rotational speed is represented in the rotational speed domain of the electric machine. In other words, dashed-dot line 202 represents the rotational speed of the electric machine if the electric machine were mechanically coupled to the axle. Solid line 204 represents the actual rotational speed of the electric machine. The length of leader 210 represents the amount of time it takes to recouple an uncoupled electric machine to an axle and complete controlled torque request ramp up (e.g., gradually increase).

At time t0, the sequence is in a mode where exactly one electric machine is coupled to the vehicle driveline and wheels (not shown) (e.g., two-wheel drive mode). The other electric machine is uncoupled from the vehicle driveline and wheels so that less electric energy may be consumed to propel the vehicle. The speed of the uncoupled electric machine is at zero or a lower speed as indicated by solid line 204. Either the front wheels or the rear wheels may be driven by the exactly one electric machine. In this example, the rear wheels are being driven via an electric machine and the front wheels are decoupled from an electric machine. The driveline rotational speed in the rotational speed domain of the electric machine of the uncoupled axle is at zero or a medium level and it is gradually increasing.

At time t1, a request to close the disconnect clutch and couple the uncoupled electric machine to the axle is generated. This begins the SDU or motor speed synchronization phase. During this phase, a rotational speed of the uncoupled electric machine is increased so that driveline components (e.g., shafts/gears etc.) that are coupled to the electric machine rotate at a rotational speed that is the same as driveline components (e.g., shafts/gears etc.) that rotate due to rotating vehicle wheels. Thus, a rotational speed of an input side of a disconnect clutch is increased to a rotational speed of an output side of the disconnect clutch, irrespective of the disconnect clutches location along the driveline. The rotational speed of the input side of the disconnect clutch is increased via increasing uncoupled electric machine rotational speed. Increasing rotational speed of the uncoupled electric machine causes solid line 204 to increase toward the dash-dot line 202.

At time t2, the driveline speed in the electric machine speed domain is equal to the SDU rotational speed within a tolerance range (e.g., +−5 rad/sec). In other words, the rotational speed of the input side of the disconnect clutch is almost the same as the rotational speed of the output side of the disconnect clutch. Therefore, this is the end of the motor speed synchronization phase and the disconnect clutch is commanded closed. Since the speeds are equal or nearly equal, the disconnect clutch slip may be reduced and torque transfer through the disconnect clutch may be smooth. The clutch engagement phase begins at time t2.

At time t3, the disconnect clutch is fully closed so output torque or power of the SDU is increased so that the MDU and SDU provide the requested driver demand torque or power. This is the end of the clutch engagement phase and the beginning of the motor torque increasing phase. The SDU torque is gradually increased until time t4 when it reaches its requested value.

Referring now to FIG. 3, plots show a requested electric machine rotational speed, desired electric machine rotational speed profile for higher urgency driveline disconnect clutch closing, and electric machine rotational speed profile for lower urgency driveline disconnect clutch closing. The vertical axis of plot 300 represents motor or electric machine rotational speed and rotational speed increases in the direction of the vertical axis arrow. The horizontal axis represents time and time increases from the left side of the plot to the right side of the plot.

Driveline disconnect clutch closing urgency level may be indicative of an amount of time that the driveline disconnect clutch is commanded to take to go from fully open to fully closed. Thus, a higher urgency driveline disconnect clutch closing urgency level results in the driveline disconnect clutch being commanded to go from fully open to fully closed in a shorter amount of time (e.g., 0.5 seconds). A lower urgency driveline disconnect clutch closing urgency level results in the driveline disconnect clutch being commanded to go from fully open to fully closed in a longer amount of time (e.g., 1.5 seconds).

Solid line 302 represents a requested or target electric machine rotational speed. In this example, the requested electric machine rotational speed is changed in a step-wise fashion.

Dashed-dot line 304 represents an electric machine rotational speed profile for a high urgency driveline disconnect clutch closing request. Dashed-dot line 304 exhibits traits of a critically damped response in that it has no oscillation and overshoot (e.g., it does not exceed the target electric machine rotational speed) and it converges to the target electric machine rotational speed profile request value. This speed profile may cause the electric machine rotational speed to reach a speed where rotational speed on an input side of the driveline disconnect clutch matches the rotational speed on the output side of the driveline disconnect clutch in a shorter period of time.

Dashed-double-dot line 306 represents an electric machine rotational speed profile for a lower urgency driveline disconnect clutch closing request. Dashed-double-dot line 306 exhibits traits of a slower response in that it has no overshoot (e.g., it does not exceed the target electric machine rotational speed) and it converges to the electric machine rotational speed profile request value at a later time that dashed-dot line 304. This speed profile may cause the electric machine rotational speed to reach a speed where rotational speed on an input side of the driveline disconnect clutch matches the rotational speed on the output side of the driveline disconnect clutch in a longer period of time.

Turning now to FIG. 4, plots illustrating synchronization phases for two different driveline disconnect clutch closing sequences are shown. The plots of FIG. 4 may be generated via the system of FIG. 1 in cooperation with the methods of FIGS. 5 and 6. Starting and ending of the different synchronization phases are indicated by vertical lines at x1-x6.

The first plot from the top of FIG. 4 is a plot of motor (e.g., electric machine) rotational speed versus time. The vertical axis represents rotational speed of a motor (e.g., the SDU) and rotational speed increases in the direction of the vertical axis arrow. The different synchronization phases are displayed relative to the horizontal axis. Trace 402 represents a request or target rotational speed for the motor. Trace 404 represents target motor rotational speed for a higher urgency driveline disconnect clutch closing after processing the signal that is represented by trace 402 (e.g., applying rate limit and filter to the signal of trace 402 to generate the signal of trace 404). Trace 406 represents target motor rotational speed profile for a lower urgency driveline disconnect clutch closing after processing the signal of trace 402 (e.g., applying a second rate limit and a second filter to the signal of trace 402 to generate the signal of trace 406).

The second plot from the top of FIG. 4 is a plot of motor rate of speed change versus time. The vertical axis represents motor rate of speed change and motor rate of speed change increases in the direction of the vertical axis arrow. The horizontal axis represents time and time increases from the left side of the plot to the right side of the plot. Trace 408 represents a motor rate of speed change for a higher urgency driveline disconnect clutch closing. Trace 410 represents a motor rate of speed change for a lower urgency driveline disconnect clutch closing.

The third plot from the top of FIG. 4 is a plot of motor feed forward torque versus time. The vertical axis represents motor feed forward torque and motor feed forward torque increases in the direction of the vertical axis arrow. The horizontal axis represents time and time increases from the left side of the plot to the right side of the plot. Trace 412 represents a motor feed forward torque for a higher urgency driveline disconnect clutch closing. Trace 414 represents a motor feed forward torque for a lower urgency driveline disconnect clutch closing.

The fourth plot from the top of FIG. 4 is a plot of motor proportionate control torque versus time. The vertical axis represents motor proportionate control torque and motor proportionate control torque increases in the direction of the vertical axis arrow. The horizontal axis represents time and time increases from the left side of the plot to the right side of the plot. Trace 416 represents a motor proportionate control torque for a higher urgency driveline disconnect clutch closing. Trace 418 represents a motor proportionate control torque for a lower urgency driveline disconnect clutch closing.

The fifth plot from the top of FIG. 4 is a plot of motor integral control torque versus time. The vertical axis represents motor integral control torque and motor integral control torque increases in the direction of the vertical axis arrow. The horizontal axis represents time and time increases from the left side of the plot to the right side of the plot. Trace 420 represents a motor integral control torque for a higher urgency driveline disconnect clutch closing. Trace 422 represents a motor integral control torque for a lower urgency driveline disconnect clutch closing.

The plots of FIG. 4 show a motor synchronization phase of a driveline disconnect clutch closing sequence for a higher urgency driveline disconnect clutch closing sequence and a motor synchronization phase of a driveline disconnect clutch closing sequence for a lower urgency driveline disconnect clutch closing sequence.

The synchronization phase of the driveline disconnect clutch closing sequence for the higher urgency driveline disconnect clutch closing sequence is subdivided into three speed control phases. The first speed control phase of the synchronization phase for the higher urgency driveline disconnect clutch closing sequence begins at x1 and it ends at x2. The first speed control phase may be referred to as a rate of electric machine speed change increasing and sustaining phase. The second speed control phase of the synchronization phase for the higher urgency driveline disconnect clutch closing sequence begins at x2 and it ends at x3. The second speed control phase may be referred to as a rate of electric machine speed change decreasing phase. The third speed control phase of the synchronization phase for the higher urgency driveline disconnect clutch closing sequence begins at x3 and it ends at x4. The third speed control phase may be referred to as a speed stabilization phase.

The synchronization phase of the driveline disconnect clutch closing sequence for the lower urgency driveline disconnect clutch closing sequence is also subdivided into three speed control phases. The first speed control phase of the synchronization phase for the lower urgency driveline disconnect clutch closing sequence begins at x1 and it ends at x5. Note that it may be understood that the end of the synchronization phase for the lower urgency driveline disconnect clutch closing may or may not be coincident with the ending of the third phase of the higher urgency driveline disconnect clutch closing sequence. The first speed control phase may be referred to as a rate of electric machine speed change increasing and sustaining phase. The second speed control phase of the synchronization phase for the lower urgency driveline disconnect clutch closing sequence begins at x5 and it ends at x6. The second speed control phase may be referred to as a rate of electric machine speed change decreasing phase. The third speed control phase of the synchronization phase for the lower urgency driveline disconnect clutch closing sequence begins at x6 and it ends at x7. The third speed control phase may be referred to as a speed stabilization.

At x1, the requested motor rotational speed (402) increases in a step-wise fashion. The target motor rotational speed for a higher urgency driveline disconnect clutch closing (404) begins to increase. Likewise, the target motor rotational speed for a lower urgency driveline disconnect clutch closing (406) begins to increase, but at a lower rate of increase than the target motor rotational speed for a higher urgency driveline disconnect clutch closing. The feed forward torque for the higher urgency driveline disconnect clutch closing sequence (412) increases quickly and then it levels out at a maximum level. Conversely, the feed forward torque for the lower urgency driveline disconnect clutch closing sequence (414) increases slower relative to trace 412. The proportional control torque for the higher urgency driveline disconnect clutch closing sequence (416) begins to increase shortly after x1 in response to the difference between the requested motor rotational speed and the actual or measured motor rotational speed for a higher urgency driveline disconnect clutch closing. The proportional control torque contribution increases quickly and then it levels out at a maximum level. Conversely, the proportional control torque for the lower urgency driveline disconnect clutch closing sequence (418) increases slower relative to trace 416. The integral control torque for the higher urgency (420) and lower urgency driveline disconnect clutch closing sequences (422) may be zero or very small values. The motor rate of speed change for higher urgency driveline disconnect clutch closing (408) begins to increase at a higher rate for the higher urgency driveline disconnect clutch closing sequence shortly after x1. The motor rate of speed change for lower urgency driveline disconnect clutch closing (410) begins to increase at a lower rate relative to the motor rate of speed change for higher urgency driveline disconnect clutch closing shortly after x1.

At x2, the requested motor rotational speed (402) has leveled off. The target motor rotational speed for a higher urgency driveline disconnect clutch closing (404) has also leveled off. Conversely, the target motor rotational speed for a lower urgency driveline disconnect clutch closing (406) continues to increase. The motor rate of speed change for higher urgency driveline disconnect clutch closing (408) has peaked and it begins to decrease. The motor rate of speed change for lower urgency driveline disconnect clutch closing (410) continues to increase at a lower rate for the lower urgency driveline disconnect clutch closing sequence. The feed forward torque for the higher urgency driveline disconnect clutch closing sequence (412) decreases quickly and then it is reduced to nearly zero shortly thereafter. Conversely, the feed forward torque for the lower urgency driveline disconnect clutch closing sequence (414) continues increasing at a slower rate. The proportional control torque for the higher urgency driveline disconnect clutch closing sequence (416) begins to decrease shortly after x2 in response to the difference between the requested motor rotational speed and the actual or measured motor rotational speed for a higher urgency driveline disconnect clutch closing. The proportional control torque for the lower urgency driveline disconnect clutch closing sequence (418) continues increasing. The integral control torque for the higher urgency and lower urgency driveline disconnect clutch closing sequences (420 and 422) begin to increase.

At x3, the requested motor rotational speed (402) is unchanged and the target motor rotational speed for a higher urgency driveline disconnect clutch closing (404) is unchanged. The target motor rotational speed for a lower urgency driveline disconnect clutch closing (406) continues to increase. The motor rate of speed change for higher urgency driveline disconnect clutch closing (408) is nearly zero and the motor rate of speed change for lower urgency driveline disconnect clutch closing (410) continues to increase at a lower rate. The feed forward torque for the higher urgency driveline disconnect clutch closing sequence (416) is zero and the feed forward torque for the lower urgency driveline disconnect clutch closing sequence (418) continues increasing at a slower rate. The proportional control torque for the higher urgency driveline disconnect clutch closing sequence (416) is reduced to a very small value varying between positive and negative values and the proportional control torque for the lower urgency driveline disconnect clutch closing sequence (418) continues increasing. The integral control torque for the higher urgency (420) and lower urgency (422) driveline disconnect clutch closing sequences begin to increase.

At x4, the higher urgency driveline disconnect clutch closing sequence ends. The higher urgency driveline disconnect clutch sequence ends with the requested motor rotational speed (402) unchanged and the target motor rotational speed for a higher urgency driveline disconnect clutch closing (404) unchanged. The motor rate of speed change for higher urgency driveline disconnect clutch closing (408) is nearly zero and the feed forward torque for the higher urgency driveline disconnect clutch closing sequence (416) is zero. The proportional control torque for the higher urgency driveline disconnect clutch closing sequence (420) is reduced to a very small value varying between positive and negative values and the integral control torque for higher urgency driveline disconnect clutch closing is zero.

At x5, the requested motor rotational speed (402) is unchanged and the target motor rotational speed for a lower urgency driveline disconnect clutch closing (406) continues to increase. The motor rate of speed change for lower urgency driveline disconnect clutch closing (410) starts to decrease. The feed forward torque for the lower urgency driveline disconnect clutch closing (414) sequence starts to decrease. The proportional control torque for the lower urgency driveline disconnect clutch closing sequence (418) is reduced to near zero. The integral control torque for lower urgency driveline disconnect clutch closing sequences (422) has leveled off to a small non-zero value.

At x6, the requested motor rotational speed (402) is unchanged. The target motor rotational speed for a lower urgency driveline disconnect clutch closing (404) has leveled off. the motor rate of speed change for lower urgency driveline disconnect clutch closing (410) is nearly zero. The feed forward torque for the lower urgency driveline disconnect clutch closing sequence (414) is close to zero. The proportional control torque for the lower urgency driveline disconnect clutch closing sequence (418) is reduced to close to zero. The integral control torque for the lower urgency driveline disconnect clutch closing sequence (422) has leveled off to small non-zero values. The low urgency driveline disconnect clutch closing sequence ends at x7.

In this way, motor commands may be adjusted in response to a requested motor speed and error between the requested motor speed and actual or measured motor speed. Control gains may be adjusted according to speed phases so that motor speed converges quickly to a target motor speed.

Referring now to FIG. 5, a flowchart of a method for determining motor speed synchronizing torque is shown. The method of FIG. 5 may be incorporated into and may cooperate with the system of FIG. 1. Further, at least portions of the method of FIG. 5 may be incorporated as executable instructions stored in non-transitory memory of one or more controllers while other portions of the method may be performed via the one or more controllers transforming operating states of devices and actuators in the physical world.

At 502, method 500 receives a control mode request. In one example, the control mode request may be for a motor speed synchronization mode that may be applied when entering a four-wheel drive mode. The control mode request may be generated when the vehicle is operating in a two-wheel drive mode. When motor speed synchronization mode is selected, the control strategy enters a special motor speed control and torque delivery control path that includes a unique control strategy. The strategy may operate such that at different urgency levels, the speed control is performed differently and motor torque commands may be requested differently. Method 500 proceeds to 504.

At 504, method 500 judges whether or not secondary drive unit (SDU) speed synchronization mode is activated. The secondary driver unit speed synchronization mode may be selected when the driveline disconnect clutch is fully open and when driveline disconnect clutch closing is requested, at the start of speed synchronization phase, for example. The secondary drive unit speed synchronization phase is a phase of driveline disconnect clutch closing where the speed of the SDU may be raised such that rotational speed of an input side of the driveline disconnect clutch is equal to the rotational speed of the output side of the driveline disconnect clutch. If method 500 judges that the SDU speed synchronization mode is active, the answer is yes and method 500 proceeds to 506. Otherwise, the answer is no and method 500 proceeds to 550.

At 550, method 500 operates the SDU according to a base speed control or a base torque control mode. In one example, the base torque control mode may determine a driver demand torque based on driver demand pedal position and vehicle speed. The torque that is requested based on the driver demand torque may be split between the SDU and the MDU. Thus, the SDU may follow a requested torque and supply the requested torque in a torque control mode. On the other hand, if the SDU is operating in a speed control mode, torque of the SDU may be adjusted so that the SDU follows a requested speed. In one example, the requested speed may be generated via a vehicle cruise control speed controller to follow a speed that has been requested by an operator of the vehicle. Method 500 proceeds to exit.

At 506, method 500 determines and classifies the requests for closing or connecting the driveline disconnect clutch into urgency levels. In one example, method 500 may classify each of the conditions or triggers for closing the driveline disconnect clutch into two categories: low urgency and high urgency. These two categories may indicate a timeliness for closing the disconnect clutch. For example, a high urgency may be for instances when the driveline disconnect clutch is to close within 200 milliseconds of being requested to do so and a low urgency may be for instances when the driveline disconnect clutch is to close within 500 milliseconds of being requested to do so.

High urgency requests for closing the disconnect clutch may be based on vehicle stability, traction control, a change in road coefficient of friction, and intent to change the vehicle's present location quickly (e.g., high and or rapidly changing driver demand torque or power) so that the vehicle may deliver four-wheel drive as soon as may be possible. Low urgency requests for closing the disconnect clutch may include but are not limited to falling or low ambient air temperature, vehicle speed change, and manual drive mode changes. Method 500 proceeds to 508.

At 508, method 500 judges if the present disconnect clutch closing or connection is of high urgency. If so, the answer is yes and method 500 proceeds to 510. Otherwise, the answer is no and method 500 proceeds to 514.

At 510, method 500 determines a motor torque command via a motor speed synchronization control for high urgency driveline disconnect clutch closing requests. The motor torque command may be determined via the method of FIG. 6. Method 500 proceeds to 512 after the motor torque command is determined.

At 512, method 500 delivers the torque that is commanded via the motor torque command via the SDU. Output of an inverter that supplies electric power to the SDU may be adjusted according to the torque command that is based on a high urgency driveline disconnect clutch closing. Method 500 proceeds to exit.

At 514, method 500 determines a motor torque command via a motor speed synchronization control for low urgency driveline disconnect clutch closing requests. The motor torque command may be determined via the method of FIG. 6. Method 500 proceeds to 516 after the motor torque command is determined.

At 516, method 500 delivers the torque that is commanded via the motor torque command via the SDU. Output of an inverter that supplies electric power to the SDU may be adjusted according to the torque command that is based on a low urgency driveline disconnect clutch closing. Method 500 proceeds to exit.

Referring now to FIG. 6, a flowchart of a method for motor speed synchronization torque determination is shown. The method of FIG. 6 may be incorporated into and may cooperate with the system of FIG. 1. Further, at least portions of the method of FIG. 6 may be incorporated as executable instructions stored in non-transitory memory while other portions of the method may be performed via a controller transforming operating states of devices and actuators in the physical world.

At 602, method 600 receives a target or requested motor speed raw (MtrSpd_targetRaw). In one example, the target or requested raw motor speed may be a step change in speed from the SDU's present rotational speed to a rotational speed that matches a rotational speed on an input side of the driveline disconnect clutch to a rotational speed on an output side of the driveline disconnect clutch. Thus, if the present SDU speed is 10 revolutions per minute and a speed of 15 revolutions per minute is needed to match the input side speed of the driveline disconnect clutch to the output side speed of the driveline disconnect clutch, then the target or requested raw motor speed changes from 10 revolutions per minute to 15 revolutions per minute in the amount of time it takes for the SDU speed controller to determine an updated raw motor speed command (e.g., 1 millisecond). Method 600 proceeds to 604.

At 604, method 600 determines a target or requested motor speed (MtrSpd_target) for the SDU. In one example, method 600 applies a rate limit (SlewRate_mtrSpd) (e.g., a constraint on the rate that motor speed may incrementally increase or decrease) to the target motor speed that constrains the rate of increase and the rate of decrease of the target motor speed raw value. Alternatively, method 600 may pass the target motor speed raw signal through a low pass filter to determine the target motor speed. The value of the rate limit may be based on the driveline disconnect clutch urgency level. For example, a greater rate limit value may be provided for a higher driveline disconnect clutch closing urgency level and a lower rate limit value may be provided for a lower driveline disconnect clutch closing urgency level. Method 600 proceeds to 606 and 607.

At 606, method 600 determines a feed forward motor torque command contribution. In one example, method 600 determines the feed forward motor torque command contribution via the following equation:

Tq_cmdFF=I_mtrLump*SlewRate_mtrSpd

where Tq_cmdFF is the feed forward motor torque command contribution to the total SDU motor torque, I_mtrLump is the lumped motor inertia, SlewRate_mtrSpd is the derivative of the target motor speed (MtrSpd_target).

At 607, method 600 determines the motor torque command feedback contribution. In one example, method 600 determines the motor torque command feedback contribution via the following equation:

Tq_cmdFB=Tq_P+Tq_I=Kp*Err_mtrSpd+f(Ki*integrate(Err_mtrSpd))
where Tq_cmdFB is the motor torque command feedback contribution to the total SDU motor torque, Kp is a proportional gain (e.g., scalar real number), Err_mtrSpd SDU motor speed error, which is the target traction motor speed (MtrSpd_target) minus the actual motor speed (MtrSpd_act), Ki is the integral gain (e.g., scalar real number), integrate is the numerical integral of Err_mtrSpd. f as a function of (Ki*integrate (Err_mtrSpd)), can either be set to 0 when the motor torque command is saturated, or set to its raw calculation which includes integrated Err_mtrSpd over time.

Thus, the feedback contribution may be determined via a proportional/integral (PI) controller. Method 600 proceeds to 608.

At 608, method 600 determines the SDU motor torque command total. In one example, the SDU motor torque command total is determined by the following equation: Tq_cmdTot=Tq_cmdFF+Tq_cmdFB. Method 600 proceeds to 610.

At 610, method 600 constrains the SDU command torque total value according to a slew rate limit, where the torque slew rate may have units of Newton-meters/second. The SDU motor torque command total is constrained according to a slew rate that is based on the urgency of closing the driveline disconnect clutch and the slew rate limited SDU motor torque command is issued to the SDU. For High urgency, the fastest torque slew rate (e.g., rate of change of torque per unit time) that the motor is capable of (e.g., the maximum motor torque slew rate) is usually used, which is much larger than that of the base motor speed control 550, to enable quickest motor torque delivery. Method 600 proceeds to 612.

The SDU motor torque command described in steps 602-610 may adjust the SDU speed in three speed phases during the speed synchronization phase of the driveline disconnect clutch closing as discussed with regard to FIG. 4 depending on the urgency level for closing the driveline disconnect clutch. The first speed phase may begin at a time when driveline disconnect clutch closing for a particular driveline disconnect clutch closing sequence is received and it may end at a time when the rate of change in SDU speed changes from increasing and sustaining to deceasing. Alternatively, the first speed phase may end when SDU speed is within a predetermined speed of the target SDU speed. The second speed phase during the speed synchronization phase of the driveline disconnect closing may begin at the end of the first speed phase and it may end when the rate of change in SDU speed is less than a threshold rate of change (e.g., less than 2 revolutions per minute). Alternatively, the second speed phase may end when SDU speed is within a second predetermined speed of the target SDU speed. The third speed phase during the speed synchronization phase of the driveline disconnect closing may begin at the end of the second speed phase and it may end at the end of the motor speed synchronization phase.

In the first speed phase during a high urgency driveline disconnect clutch closing, the design objectives may be to deliver that fastest rate of rotational speed change for the SDU and to reduce the possibility of the SDU overshooting (e.g., exceeding) the target rotational speed for the SDU. The dominate torque command may be the feed forward torque command and the feed forward torque command may be adjusted to the maximum torque for the SDU. The slew rate for the SDU may be set to (Tq_mtrMax/I_mtrLump)+offset1, where Tq_mtrMax is maximum SDU torque at the present SDU speed and I_mtrLump is the lumped inertia of the SDU, and offset1 is a small positive offset value. Since the SDU torque command is at a maximum value, the proportional torque is immaterial. The integral torque may be set to zero to reduce a possibility of excess integral torque accumulation.

In the first speed phase during a low urgency driveline disconnect clutch closing, the design objectives may be to deliver a rate of rotational speed change for the SDU that meets a desired synchronization time disconnect clutch closing smoothness and to reduce the possibility of the SDU overshooting the target rotational speed for the SDU. The dominate torque command may be the feed forward torque command and the proportional torque command may provide assistance torque. The feed forward torque command may be adjusted to Tq_cmdFF=I_mtrLump*SlewRate_mtrSpd, where SlewRate_mtrSpd=(Steady State Value of MtrSpd_targetRaw)/(Time_syncP1−offset2). The variable Time_syncP1 is the desired amount of time for speed synchronization. The proportional torque may be adjusted according to the following equation: Tq_P=Kp*Err_mtrSpd such that Kp is selected so that Tq_P is <Tq_cmdFF. The value of Kp may be empirically determined via adjusting Kp for several disconnect clutch closing events and monitoring Tq_P and Tq_cmdFF. Kp values may be scheduled such that Kp=f (Err_mtrSpd, mtrSpd_target). For example, Kp can decrease when Err_mtrSpd becomes small but is still positive, Kp can increase when Err_mtrSpd becomes negative, and Kp can decrease along with the increase of mtrSpd_target. The integral gain Ki may be set to a small scalar such that the integral torque is small relative to the proportional torque.

In the second speed phase during a high urgency driveline disconnect clutch closing, the design objectives may be to slow the rate of SDU speed change quickly to reduce a possibility of overshoot and to maintain some positive rate of SDU speed change to quickly meet the target motor or SDU speed. The dominant torque contribution is from the proportional torque contribution and the feed forward torque command is set to zero or substantially zero (e.g., less than 10 Newton-meters). The value of Kp may be empirically determined via adjusting Kp for several disconnect clutch closing events and monitoring Tq_P and Tq_cmdFF. Kp values may be scheduled such that Kp=f (Err_mtrSpd, mtrSpd_target). The integral gain Ki may be set to a small scalar such that the integral torque is small relative to the proportional torque.

In the second speed phase during a low urgency driveline disconnect clutch closing, the design objectives may be to slow the rate of SDU speed change quickly to reduce a possibility of overshoot and to maintain some rate of SDU speed change to smoothly meet the target motor or SDU speed. The dominate torque command may be the feed forward torque command and the proportional torque command may provide assistance torque. The feed forward torque command may be adjusted to Tq_cmdFF=I_mtrLump*SlewRate_mtrSpd. The proportional torque may be adjusted according to the following equation: Tq_P=Kp*Err_mtrSpd such that Kp is selected so that Tq_P is <Tq_cmdFF. The value of Kp may be empirically determined via adjusting Kp for several disconnect clutch closing events and monitoring Tq_P and Tq_cmdFF. Kp values may be scheduled such that Kp=f (Err_mtrSpd, mtrSpd_target). The integral gain Ki may be set to a small scalar such that the integral torque is small relative to the proportional torque.

In the third speed phase during a high urgency driveline disconnect clutch closing, the design objectives may be to approach the target motor or SDU speed slowly and reduce a possibility of speed oscillations. The feed forward torque command is set to zero or substantially zero. The feedback torque command is Tq_cmdFB=Tq_P+Tq_I, where the Tq_P and Tq_I values are small. Kp values may be scheduled such that Kp=f (Err_mtrSpd, mtrSpd_target). The integral gain Ki may be scheduled such that Ki=f (Err_mtrSpd, mtrSpd_target) as well.

In the third speed phase during a low urgency driveline disconnect clutch closing, the design objectives may be to approach the target motor or SDU speed slowly and reduce a possibility of speed oscillations. The feed forward torque command is set to zero or substantially zero. The feedback torque command is Tq_cmdFB=Tq_P+Tq_I, where the Tq_P and Tq_I values are small. Kp values may be scheduled such that Kp=f (Err_mtrSpd, mtrSpd_target). The integral gain Ki may be scheduled such that Ki=f (Err_mtrSpd, mtrSpd_target) as well.

At 612, method 600 judges whether or not the rotational speed of the SDU is at the target motor speed. If so, the answer is yes and method 600 proceeds to 614. Otherwise, the answer is no and method 600 returns to 602.

At 614, method 600 enters the second phase of driveline disconnect clutch closing and commands the driveline disconnect clutch to close. Method 600 proceeds to exit.

Thus, method 600 may adjust a SDU torque command via applying different target motor speed slew rates, control gains (Ki and Kp) with different values for different speed phases of a speed synchronization phase for driveline disconnect clutch closing. In this way, the gains may be changed so that motor speed converges to the target motor speed is a desired amount of time so that the driveline disconnect clutch may be closed smoothly so as to reduce a possibility of driveline torque disturbances.

The methods described herein provide for a method for operating a vehicle, comprising: a first motor speed control algorithm or a first motor torque control algorithm for a first operating mode; and a second motor speed control algorithm for a second operating mode, where the second operating mode is a motor speed synchronization mode performed during driveline disconnect clutch closing. In a first example, the method includes where the second motor speed control algorithm adjusts a speed of a traction motor according to target motor speed, where the target motor speed is based on an urgency level of driveline disconnect clutch closing, and where the urgency level is high. In a second example that may include the first example, the method further comprises commanding a maximum traction motor torque output in response to the urgency level being high. In a third example that may include one or both of the first and second examples, the method further comprises adjusting a traction motor speed slew rate target during a first phase of the second operating mode as a maximum traction motor torque divided by a lumped traction motor inertia plus an offset, and where an actual delivered motor speed rate of change during the first phase of the second operating mode is a maximum that a motor is capable of when the urgency level is high. In a four example that may include one or more of the first through third examples, the method includes where the second motor speed control algorithm adjusts a speed of a traction motor according to target motor speed, where the target motor speed is based on an urgency level of driveline disconnect clutch closing, and where the urgency level is low. In a fifth example that may include one or more of the first through fourth examples, the method further comprises adjusting a traction motor speed slew rate target during a first phase of the second operating mode based on a target traction motor speed and a desired traction motor speed synchronization time, and where the traction motor speed slew rate target decreases for an increasing desired traction motor speed synchronization time for when the urgency level is low. In a sixth example that may include one or more of the first through fifth examples, the method includes where the second motor speed control algorithm adjusts a torque of a traction motor according to a second torque slew rate, the second torque slew rate greater than a torque slew rate for the first operating mode.

In another representation, the methods described herein provide for operating a vehicle, comprising: adjusting torque of an electric machine during a speed synchronization phase of a closing of a driveline disconnect clutch according to separate and distinct speed control phases within the speed synchronization phase. In a first example, the method includes where the closing of the driveline disconnect clutch includes three driveline disconnect clutch closing phases including the speed synchronization phase, a disconnect clutch engagement phase, and an electric machine torque increase phase. In a second example that may include the first example, the method includes where the disconnect clutch engagement phase follows the speed synchronization phase, and where the disconnect clutch engagement phase precedes the electric machine torque increase phase during the closing of a driveline disconnect clutch. In a third example that may include one or both of the first and second examples, the method further comprises adjusting torque of the electric machine within the separate and distinct speed control phases based on a driveline disconnect clutch closing urgency level. In a fourth example that may include one or more of the first through third examples, the method includes where the separate and distinct speed control phases include a rate of electric machine speed increasing and sustaining phase, a rate of electric machine speed decreasing phase, and a rate of electric machine speed stabilization phase. In a fifth example that may include one or more of the first through fourth examples, the method includes where torque of the electric machine is adjusted via a feed forward torque, a proportional torque, and an integral torque during the rate of electric machine speed increasing phase, the rate of electric machine speed decreasing phase, and the rate of electric machine speed stabilization phase. In a sixth example that may include one or more of the first through fifth examples, the method includes where a proportional gain and an integral gain for generating the proportional torque and the integral torque in the rate of electric machine speed increasing phase are different from the proportional gain and the integral gain for generating the proportional torque and the integral torque in the rate of electric machine speed decreasing phase.

The methods described herein provide for a method for operating a vehicle, comprising: performing closing of a driveline disconnect clutch in three driveline disconnect clutch closing phases including a motor speed synchronization phase, a driveline disconnect clutch engagement phase, and an electric machine torque increasing phase, wherein the motor speed synchronization phase includes three speed control phases including a rate of motor speed change increasing and sustaining phase, a rate of motor speed change decreasing phase, and a rate of motor speed change stabilization phase. In a first example, the method further comprises adjusting a traction motor speed slew rate target during a first phase of the three speed control phases based on a steady-state value of a raw traction motor speed target value and a desired traction motor speed synchronization time. In a second example that may include the first example, the method includes where the traction motor speed slew rate target decreases for an increasing desired traction motor speed synchronization time for when an urgency level is low. In a third example that may include one or both of the first and second examples, the method further comprises adjusting a torque of an electric machine in each of the three speed control phases. In a fourth example that may include one or more of the first through third examples, the method includes where the torque is adjusted based on a plurality of gains for driveline disconnect clutch urgency levels.

Note that the example control and estimation routines included herein can be used with various vehicle system configurations. The control methods and routines disclosed herein may be stored as executable instructions in non-transitory memory and may be carried out by the control system including the controller in combination with the various sensors, actuators, and other vehicle hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing described is not the exclusive way to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle control system, where the described actions are carried out by executing the instructions in a system including the various vehicle hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to drivelines with disconnect clutches that are placed at different locations in a driveline. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating a vehicle, comprising:
a first motor speed control algorithm or a first motor torque control algorithm for a first operating mode; and
a second motor speed control algorithm for a second operating mode, where the second operating mode is a motor speed synchronization mode performed during driveline disconnect clutch closing.

2. The method of claim 1, where the second motor speed control algorithm adjusts a speed of a traction motor according to target motor speed, where the target motor speed is based on an urgency level of driveline disconnect clutch closing, and where the urgency level is high.

3. The method of claim 2, further comprising commanding a maximum traction motor torque output during a first phase of the second operating mode in response to the urgency level being high.

4. The method of claim 2, further comprising adjusting a traction motor speed slew rate target during a first phase of the second operating mode as a maximum traction motor torque divided by a lumped traction motor inertia plus an offset, and where an actual delivered motor speed rate of change during the first phase of the second operating mode is a maximum that a motor is capable of when the urgency level is high.

5. The method of claim 1, where the second motor speed control algorithm adjusts a speed of a traction motor according to target motor speed, where the target motor speed is based on an urgency level of driveline disconnect clutch closing, and where the urgency level is low.

6. The method of claim 5, further comprising adjusting a traction motor speed slew rate target during a first phase of the second operating mode based on a steady-state value of a raw traction motor speed target value and a desired traction motor speed synchronization time, and where the traction motor speed slew rate target decreases for an increasing desired traction motor speed synchronization time for when the urgency level is low.

7. The method of claim 1, where the second motor speed control algorithm adjusts a torque of a traction motor according to a second torque slew rate, the second torque slew rate is greater than a torque slew rate for the first operating mode.

8. A vehicle system, comprising:
a first electric machine selectively coupled to a front axle via a disconnect clutch;
a second electric machine coupled to a rear axle;
one or more controllers including executable instructions stored in non-transitory memory that cause the one or more controllers to control a speed of the first electric machine during a closing sequence for the disconnect clutch according to a driveline speed, where the speed of the first electric machine is controlled based on an urgency of engagement of the disconnect clutch, where the urgency of engagement is based on one or more vehicle operating conditions.

9. The vehicle system of claim 8, where the closing sequence includes three phases, the three phases including an electric machine speed synchronization phase, a disconnect clutch engagement phase, and an electric machine torque increasing phase, where the disconnect clutch engagement phase follows the electric machine speed synchronization phase and precedes the electric machine torque increasing phase.

10. The vehicle system of claim 9, where the electric machine speed synchronization phase is sectioned into a first phase, a second phase, and a third phase.

11. The vehicle system of claim 10, where the first phase is a rate of electric machine speed change increasing and sustaining phase, where the second phase is a rate of electric machine speed change decreasing phase, and the third phase is a rate of electric machine speed change stabilization phase.

12. The vehicle system of claim 8, further comprising additional executable instructions that cause the one or more controllers to adjust torque of the first electric machine in response to a present speed of the first electric machine.

13. The vehicle system of claim 12, where torque of the first electric machine is adjusted via a feed forward controller and a proportional/integral controller.

14. The vehicle system of claim 13, where the feed forward controller includes a motor speed slew rate target value for each of a plurality of different urgency levels, and where the proportional/integral controller includes gains for the plurality of different urgency levels.

15. The vehicle system of claim 14, where the proportional/integral controller includes gains that are dynamically adjusted based on a target motor speed and a motor speed error for three speed control phases of an electric machine speed synchronization phase.

16. A method for operating a vehicle, comprising:
performing closing of a driveline disconnect clutch in three driveline disconnect clutch closing phases including a motor speed synchronization phase, a driveline disconnect clutch engagement phase, and an electric machine torque increasing phase, wherein the motor speed synchronization phase includes three speed control phases including a rate of motor speed change increasing and sustaining phase, a rate of motor speed change decreasing phase, and a rate of motor speed change stabilization phase.

17. The method of claim 16, further comprising adjusting a traction motor speed slew rate target during a first phase of the three speed control phases based on a steady-state value of a raw traction motor speed target value and a desired traction motor speed synchronization time when an urgency level is low.

18. The method of claim 17, where the traction motor speed slew rate target decreases for an increasing desired traction motor speed synchronization time for when an urgency level is low.

19. The method of claim 16, further comprising adjusting a torque of an electric machine in each of the three speed control phases.

20. The method of claim 19, where the torque is adjusted based on motor speed slew rate target value and a plurality of gains for driveline disconnect clutch urgency levels, and where a maximum traction motor torque is commanded during a first phase of a second operating mode in response to an urgency level being high.
